(19) United States
(12) Patent Application Publication
(10) Pub. No.: US 2023/0252683 A1
(43) Pub. Date: Aug. 10, 2023

(54) IMAGE PROCESSING DEVICE, IMAGE PROCESSING METHOD, AND COMPUTER-READABLE RECORDING MEDIUM STORING IMAGE PROCESSING PROGRAM

(71) Applicant: FUJITSU LIMITED, Kawasaki-shi (JP)

(72) Inventors: Tomonori KUBOTA, Kawasaki (JP); Xuying LEI, Kawasaki (JP); Takanori NAKAO, Kawasaki (JP)

(73) Assignee: FUJITSU LIMITED, Kawasaki-shi (JP)

(21) Appl. No.: 18/300,433

(22) Filed: Apr. 14, 2023

Related U.S. Application Data
(63) Continuation of application No. PCT/JP2020/046729, filed on Dec. 15, 2020.

(51) Int. Cl. G06T 9/00; G06N 3/084

(52) U.S. Cl. CPC G06T 9/00; G06N 3/084

(57) ABSTRACT

An image processing device includes: a memory; and a processor coupled to the memory and configured to: calculate a degree of influence of each pixel of image data, the influence being exerted on a processing result when the image data is input to a deep learning model; reduce an information amount of intermediate information extracted from the deep learning model based on the degree of influence; and compress the intermediate information, the information amount of which has been reduced.

### CROSS-REFERENCE TO RELATED APPLICATION

This application is a continuation application of International Application PCT/JP2020/046729 filed on Dec. 15, 2020 and designated the U.S., the entire contents of which are incorporated herein by reference.

### FIELD

The embodiments discussed herein are related to an image processing device, an image processing method, and an image processing program.

### BACKGROUND

As a technique of compressing and transmitting image data to be used for image analysis processing by a deep learning model, there has been known a technique of inputting image data to a deep learning model in advance and compressing and transmitting intermediate information (feature map) extracted from an intermediate layer, for example. According to the compression technique, a higher compression rate may be achieved as compared with a case of directly compressing and transmitting the image data, and an appropriate processing result may be output in the output layer of the deep learning model of the transmission destination in a similar manner to the case of directly compressing and transmitting the image data.

Japanese Laid-open Patent Publication No. 2018-195231, Japanese Laid-open Patent Publication No. 2019-036899, Japanese Laid-open Patent Publication No. 2018-097662, and Japanese Laid-open Patent Publication No. 2019-029938 are disclosed as related art.

### SUMMARY

According to an aspect of the embodiments, an image processing device includes: a memory; and a processor coupled to the memory and configured to: calculate a degree of influence of each pixel of image data, the influence being exerted on a processing result when the image data is input to a deep learning model; reduce an information amount of intermediate information extracted from the deep learning model based on the degree of influence; and compress the intermediate information, the information amount of which has been reduced.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary system configuration of an image processing system;

FIG. 2 is a diagram illustrating an exemplary hardware configuration of an edge device;

FIG. 3 is a first diagram illustrating an exemplary functional configuration of an image reduction unit, an important point extraction unit, and a compression unit of the edge device;

FIG. 4 is a first diagram illustrating a specific example of a process performed by the image reduction unit and the important point extraction unit;

FIG. 5 is a first flowchart illustrating a flow of a compression process performed by the edge device;

FIG. 6 is a second diagram illustrating an exemplary functional configuration of the image reduction unit, the important point extraction unit, and the compression unit of the edge device;

FIG. 7 is a second diagram illustrating a specific example of the process performed by the image reduction unit and the important point extraction unit;

FIG. 8 is a second flowchart illustrating a flow of the compression process performed by the edge device;

FIG. 9 is a third diagram illustrating an exemplary functional configuration of the image reduction unit, the important point extraction unit, and the compression unit of the edge device;

FIG. 10 is a third diagram illustrating a specific example of the process performed by the image reduction unit and the important point extraction unit;

FIG. 11 is a third flowchart illustrating a flow of the compression process performed by the edge device;

FIG. 12 is a fourth diagram illustrating an exemplary functional configuration of the image reduction unit, the important point extraction unit, and the compression unit of the edge device;

FIG. 13 is a fourth diagram illustrating a specific example of the process performed by the image reduction unit and the important point extraction unit; and

FIG. 14 is a fourth flowchart illustrating a flow of the compression process performed by the edge device.

### DESCRIPTION OF EMBODIMENTS

However, the intermediate information extracted from the intermediate layer of the deep learning model includes not only information needed to output the appropriate processing result in the output layer but also information not needed to output the appropriate processing result.

In one aspect, an object is to improve a compression rate at a time of compressing intermediate information extracted from a deep learning model.

Hereinafter, each embodiment will be described with reference to the accompanying drawings. Note that, in the present specification and the drawings, constituent elements having substantially the same functional configuration are denoted by the same reference sign, and redundant description will be omitted.

### First Embodiment

### <System Configuration of Image Processing System>

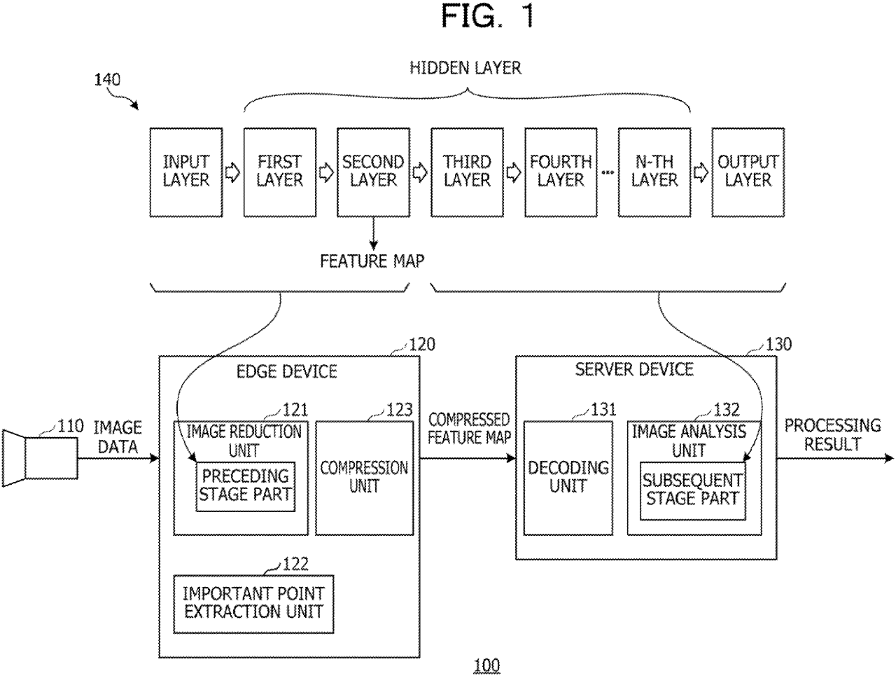

First, a system configuration of an entire image processing system including an edge device, which is an exemplary image processing device according to a first embodiment, will be described. FIG. 1 is a diagram illustrating an exemplary system configuration of the image processing system.

As illustrated in FIG. 1, an image processing system 100 includes an imaging device 110, an edge device 120, and a server device 130.

The imaging device 110 performs imaging at a predetermined frame period, and transmits image data to the edge device 120. Note that it is assumed that image data may include an object to be subject to image analysis processing using a deep learning model to be described later. When the image data does not include the object to be subject to the image analysis processing using the deep learning model to be described later, for example, the entire image data is invalidated by image processing to be described later.

An image processing program is installed in the edge device 120, and execution of the program causes the edge device 120 to function as an image reduction unit 121, an important point extraction unit 122, and a compression unit 123.

The image reduction unit 121 is an exemplary reduction unit, which has a deep learning model 140. As illustrated in FIG. 1, in the present embodiment, each layer from an input layer to an intermediate layer (e.g., second layer) from which intermediate information (“feature map”) is extracted in the deep learning model 140 will be referred to as a preceding stage part. Furthermore, each layer from the layer next to the intermediate layer from which the feature map is extracted to an output layer in the deep learning model 140 will be referred to as a subsequent stage part.

The image reduction unit 121 reduces the information amount of the image data input to the preceding stage part, thereby reducing the information amount of the feature map extracted from the intermediate layer (e.g., second layer) located at the rearmost position in the preceding stage part. As a result, the image reduction unit 121 generates a “post-reduction feature map”. Furthermore, the image reduction unit 121 notifies the compression unit 123 of the generated post-reduction feature map.

The important point extraction unit 122 is an exemplary calculation unit, which generates an “important feature map” indicating a degree of influence of each pixel that affects the processing result of the deep learning model 140 in the image data. The generated important feature map is notified to the image reduction unit 121, and is used at the time of reducing the information amount of the image data input to the preceding stage part.

The compression unit 123 compresses the post-reduction feature map notified from the image reduction unit 121 by performing quantization and/or encoding processing, thereby generating a “compressed feature map”. Furthermore, the compression unit 123 transmits the compressed feature map to the server device 130.

As described above, in the first embodiment, the information amount of the feature map is reduced by reducing the information amount of the image data at the time of compressing the feature map extracted from the intermediate layer of the deep learning model 140 to generate the post-reduction feature map, which is then compressed. As a result, according to the first embodiment, it becomes possible to improve a compression rate at the time of compressing the feature map.

An image analysis processing program is installed in the server device 130, and execution of the program causes the server device 130 to function as a decoding unit 131 and an image analysis unit 132.

The decoding unit 131 receives the compressed feature map transmitted from the edge device 120, and performs inverse quantization and/or decoding processing on the received compressed feature map, thereby generating a post-reduction feature map. Furthermore, the decoding unit 131 notifies the image analysis unit 132 of the generated post-reduction feature map.

The image analysis unit 132 includes the subsequent stage part of the deep learning model 140, and inputs the post-reduction feature map notified from the decoding unit 131, thereby outputting a processing result from the output layer.

### <Hardware Configuration of Edge Device>

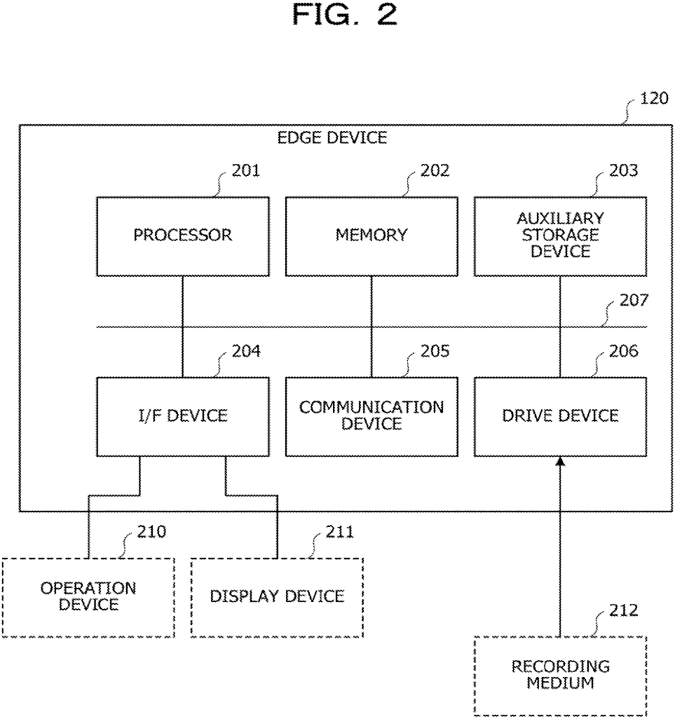

Next, a hardware configuration of the edge device 120 will be described. FIG. 2 is a diagram illustrating an exemplary hardware configuration of the edge device. The edge device 120 includes a processor 201, a memory 202, an auxiliary storage device 203, an interface (I/F) device 204, a communication device 205, and a drive device 206. Note that the individual pieces of hardware of the edge device 120 are coupled to each other via a bus 207.

The processor 201 includes various arithmetic devices such as a central processing unit (CPU) and a graphics processing unit (GPU). The processor 201 reads various programs (e.g., image processing program, etc.) onto the memory 202, and executes them.

The memory 202 includes a main storage device such as a read only memory (ROM) or a random access memory (RAM). The processor 201 and the memory 202 form what is called a computer, and the processor 201 executes various programs read onto the memory 202 to cause the computer to implement various functions (image reduction unit 121, important point extraction unit 122, and compression unit 123). Note that details of the functional configuration of various functions will be described later.

The auxiliary storage device 203 stores various programs and various types of data to be used when the various programs are executed by the processor 201.

The I/F device 204 is a coupling device that couples the edge device 120 with an operation device 210 and a display device 211, which are exemplary external devices. The I/F device 204 receives an operation performed on the edge device 120 via the operation device 210. Furthermore, the I/F device 204 outputs a result of internal processing by the edge device 120, and displays it via the display device 211.

The communication device 205 is a communication device for communicating with another device. In the case of the image processing system 100, the edge device 120 communicates with the imaging device 110 and the server device 130 via the communication device 205.

The drive device 206 is a device for setting a recording medium 212. The recording medium 212 referred to here includes a medium that optically, electrically, or magnetically records information, such as a compact disc read only memory (CD-ROM), a flexible disk, a magneto-optical disk, or the like. Furthermore, the recording medium 212 may include a semiconductor memory or the like that electrically records information, such as a ROM, a flash memory, or the like.

Note that the various programs to be installed in the auxiliary storage device 203 are installed, for example, when the distributed recording medium 212 is set in the drive device 206 and the various programs recorded in the recording medium 212 are read by the drive device 206. Alternatively, the various programs to be installed in the auxiliary storage device 203 may be installed by being downloaded from a network via the communication device 205.

### <Functional Configuration of Image Reduction Unit, Important Point Extraction Unit, and Compression Unit>

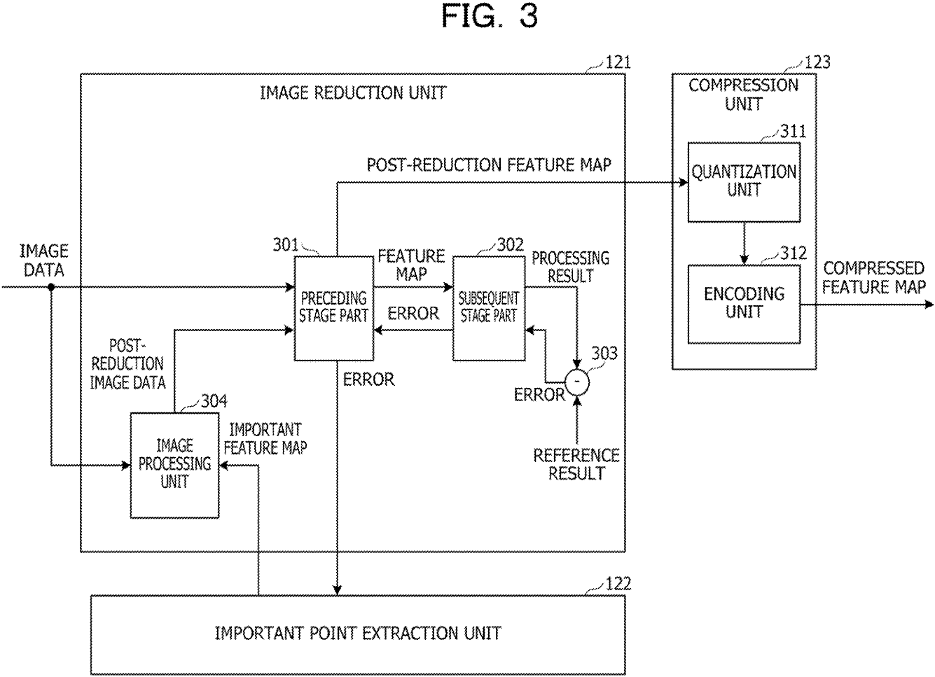

Next, details of the functional configuration of various functions (image reduction unit 121, important point extraction unit 122, and compression unit 123) implemented by the image processing program being executed in the edge device 120 will be described. FIG. 3 is a first diagram illustrating an exemplary functional configuration of the image reduction unit, the important point extraction unit, and the compression unit of the edge device.

As illustrated in FIG. 3, the image reduction unit 121 includes a preceding stage part 301, a subsequent stage part 302, an error calculation unit 303, and an image processing unit 304.

The preceding stage part 301 includes individual layers from the input layer to the intermediate layer from which the feature map is extracted in the deep learning model 140. When the image data is input, the preceding stage part 301 extracts the feature map from the intermediate layer, and notifies the subsequent stage part 302 of it. Furthermore, when “post-reduction image data” is input, the preceding stage part 301 extracts the post-reduction feature map from the intermediate layer, and notifies the compression unit 123 of it. Note that the post-reduction image data is an image generated by the image data being processed based on the important feature map, which is generated by the image processing unit 304 (details will be described later).

The subsequent stage part 302 includes individual layers from the layer next to the intermediate layer from which the feature map is extracted to the output layer in the deep learning model 140. When the feature map is input to the subsequent stage part 302, a processing result is output from the output layer. Furthermore, the subsequent stage part 302 notifies the error calculation unit 303 of the processing result output from the output layer.

The error calculation unit 303 calculates an error between the processing result notified from the subsequent stage part 302 and a reference result. The reference result indicates a classification probability determined in advance for the object (ground truth data) included in the image data. For example, in a case where the image processing system 100 is a system intended to provide a processing result to be used to analyze behavior of a person present in image data, for example, a dataset with the following characteristics or the like is defined as the reference result in the image reduction unit 121:
a classification probability of 0.8 that an object in a predetermined area (x₁, y₁, h₁, w₁) of the image data is recognized as a person; and
a classification probability of 0.1 that the object in the predetermined area (x₁, y₁, h₁, w₁) of the image data is recognized as an object other than a person.

Furthermore, the error between the processing result and the reference result indicates, for example, a difference between a classification probability of each object of the processing result notified from the subsequent stage part 302 and a classification probability of each object of the reference result. Note that the error may include, in addition to the difference between the classification probabilities, an index (e.g., intersection over union (IoU)) indicating a deviation amount between a predetermined area included in the processing result notified from the subsequent stage part 302 and a predetermined area included in the reference result.

Furthermore, the error calculation unit 303 performs backward propagation of the calculated error. As a result, the important point extraction unit 122 is enabled to generate the important feature map indicating the degree of influence of each pixel that affects the processing result of the deep learning model 140 in the image data.

Note that a method by which the error calculation unit 303 performs the backward propagation of the error includes a plurality of methods such as “normal backpropagation”, “guided backpropagation”, “selective backpropagation”, and “extended selective backpropagation”.

The normal backpropagation is a method that performs the backward propagation of the error of all the processing results notified from the subsequent stage part 302. Furthermore, the guided backpropagation is a method that performs the backward propagation of the error using only a gradient of a positive value among gradients calculated by the individual layers in the preceding stage part 301 and the subsequent stage part 302.

Furthermore, the selective backpropagation is a method that performs the backward propagation of only the error of ground truth processing result among the processing results notified from the subsequent stage part 302 using the “normal backpropagation” or the “guided backpropagation”.

The extended selective backpropagation is a method that performs the backward propagation of the magnitude error obtained by performing a predetermined operation on the processing result notified from the subsequent stage part 302 using the “normal backpropagation” or the “guided backpropagation”.

The image processing unit 304 reduces the information amount of the image data by processing the image data using the important feature map notified from the important point extraction unit 122 to be described later, and generates the post-reduction image data. For example, the image processing unit 304 processes the image data based on the degree of influence of each pixel of the important feature map notified from the important point extraction unit 122, thereby reducing the information amount of the image data and generating the post-reduction image data.

Note that a method of processing the image data by the image processing unit 304 is optional, and for example, a pixel with a degree of influence equal to or lower than a predetermined threshold may be specified in the important feature map, and the pixel value of the specified pixel in the image data may be set to zero (the specified pixel may be invalidated). Alternatively, a pixel with a degree of influence equal to or lower than the predetermined threshold may be specified in the important feature map, and the specified pixel may be subject to low-pass filtering in the image data. Alternatively, a pixel with a degree of influence equal to or lower than the predetermined threshold may be specified in the important feature map, and the color of the image data may be reduced with the specified pixel as a target. For example, processing the image data indicates processing the image data such that the deep learning model 140 does not regard an unnecessary feature as a feature, and any processing method is permissible as long as the processing method achieves the objective.

Furthermore, the image processing unit 304 notifies the preceding stage part 301 of the generated post-reduction image data. Note that, as described above, the post-reduction feature map is extracted from the intermediate layer in the preceding stage part 301 to which the post-reduction image data is notified, and is notified to the compression unit 123.

The important point extraction unit 122 generates an important feature map using the error having been subject to the backward propagation. As described above, the important feature map indicates the degree of influence of each pixel in the image data on the processing result. The important point extraction unit 122 notifies the image processing unit 304 of the generated important feature map.

Furthermore, as illustrated in FIG. 3, the compression unit 123 includes a quantization unit 311 and an encoding unit 312.

The quantization unit 311 quantizes the post-reduction feature map notified from the preceding stage part 301 of the image reduction unit 121, and notifies the encoding unit 312 of it.

The encoding unit 312 performs, for example, entropy encoding processing on the quantized post-reduction feature map notified from the quantization unit 311, or performs another optional compression processing, thereby generating a compressed feature map. Furthermore, the encoding unit 312 transmits the generated compressed feature map to the server device 130.

### <Specific Example of Processing of Image Reduction Unit and Important Point Extraction Unit>

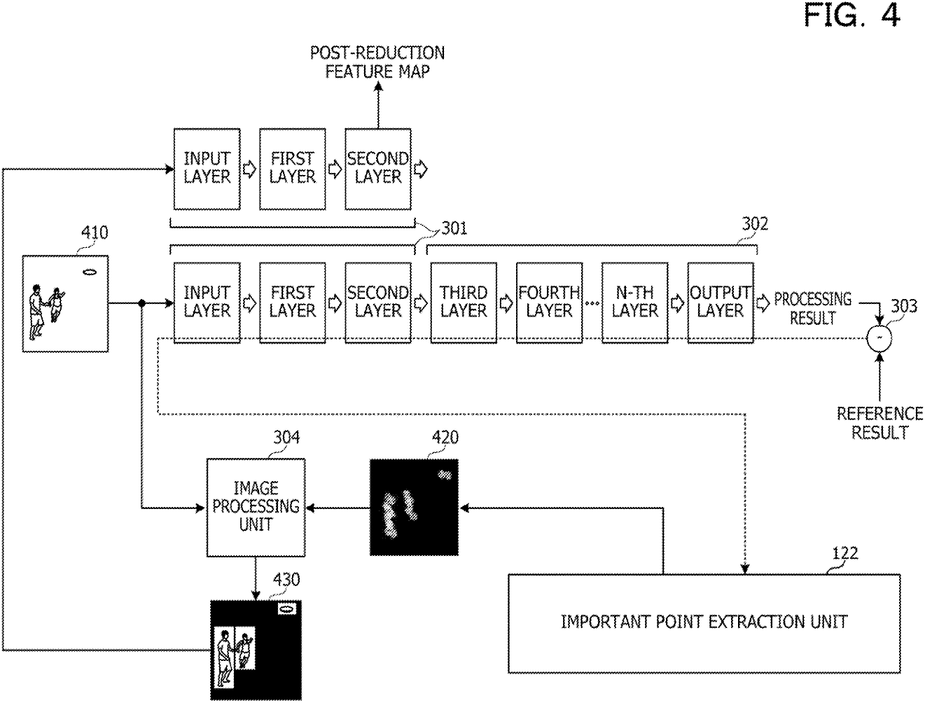

Next, a specific example of the process performed by the image reduction unit 121 and the important point extraction unit 122 of the edge device 120 will be described. FIG. 4 is a first diagram illustrating a specific example of the process performed by the image reduction unit and the important point extraction unit. As illustrated in FIG. 4, when image data 410 is input, the preceding stage part 301 and the subsequent stage part 302 in the image reduction unit 121 operate to output a processing result. Subsequently, the error calculation unit 303 operates in the image reduction unit 121 to calculate an error between the processing result and the reference result, and then performs backward propagation of the calculated error.

Subsequently, the important point extraction unit 122 operates to generate an important feature map 420 using the error having been subject to the backward propagation. Note that, in the case of the important feature map 420 illustrated in FIG. 4, pixels having a large degree of influence on the processing result are indicated in white, and pixels having a small degree of influence are indicated in black.

Subsequently, the image processing unit 304 operates in the image reduction unit 121 to invalidate pixels with the degree of influence equal to or lower than a predetermined threshold in the important feature map 420 in the image data 410, thereby generating post-reduction image data 430.

Subsequently, the post-reduction image data 430 is input to the preceding stage part 301 in the image reduction unit 121 to cause the preceding stage part 301 to operate again, and a feature map is extracted from the intermediate layer (second layer in the example of FIG. 4) of the preceding stage part 301. Moreover, the image reduction unit 121 notifies the compression unit 123 of the extracted feature map as the post-reduction feature map.

### <Compression Process Flow of Edge Device>

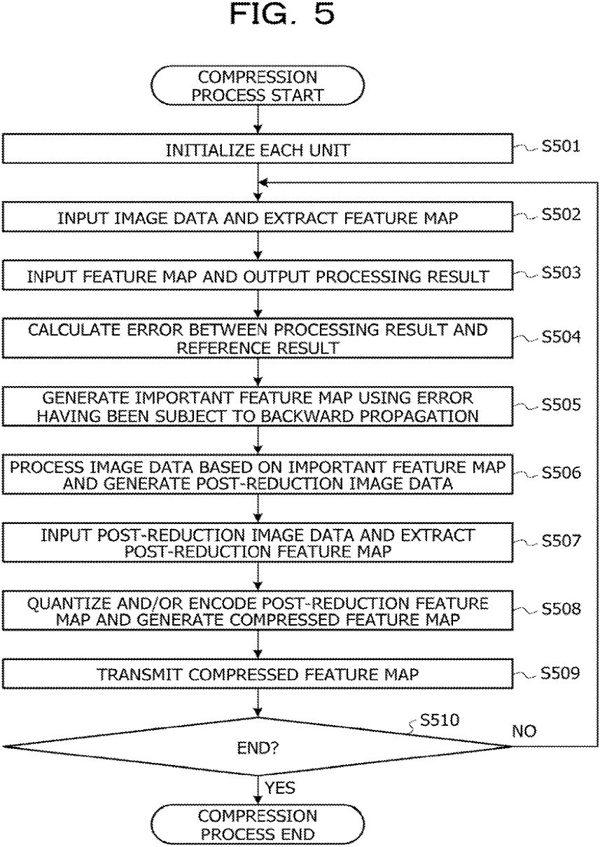

Next, a flow of a compression process performed by the edge device 120 will be described. FIG. 5 is a first flowchart illustrating a flow of the compression process performed by the edge device;

In step S501, individual units (here, preceding stage part 301 and subsequent stage part 302) of the image reduction unit 121 of the edge device 120 and the important point extraction unit 122 are initialized.

In step S502, the image reduction unit 121 of the edge device 120 causes the preceding stage part 301 to operate. When image data is input, the preceding stage part 301 extracts a feature map.

In step S503, the image reduction unit 121 of the edge device 120 causes the subsequent stage part 302 to operate. When the feature map is input, the subsequent stage part 302 outputs a processing result.

In step S504, the image reduction unit 121 of the edge device 120 causes the error calculation unit 303 to operate. The error calculation unit 303 calculates an error between the processing result and the reference result to perform backward propagation of the calculated error.

In step S505, the important point extraction unit 122 of the edge device 120 generates an important feature map using the error having been subject to the backward propagation.

In step S506, the image reduction unit 121 of the edge device 120 causes the image processing unit 304 to operate. The image processing unit 304 processes the image data based on the important feature map to reduce the information amount of the image data, thereby generating post-reduction image data.

In step S507, the image reduction unit 121 of the edge device 120 causes the preceding stage part 301 to operate again. When the post-reduction image data is input, the preceding stage part 301 extracts a post-reduction feature map.

In step S508, the compression unit 123 of the edge device 120 causes the quantization unit 311 and/or the encoding unit 312 to operate. The quantization unit 311 and/or the encoding unit 312 performs quantization and/or encoding processing on the post-reduction feature map, thereby generating a compressed feature map.

In step S509, the compression unit 123 of the edge device 120 transmits the compressed feature map to the server device 130.

In step S510, the image reduction unit 121 of the edge device 120 determines whether or not to end the compression process, and if it is determined to continue (in the case of No in step S510), the process returns to step S502.

On the other hand, if it is determined to end the compression process in step S510 (in the case of Yes in step S510), the compression process is terminated.

As is clear from the descriptions above, the image processing device (edge device 120) according to the first embodiment calculates a degree of influence of each pixel of image data, which affects the processing result when the image data is input to the deep learning model 140, and generates an important feature map. Furthermore, the image processing device (edge device 120) according to the first embodiment processes the image data based on the important feature map, thereby reducing the information amount of the image data. Furthermore, the image processing device (edge device 120) according to the first embodiment inputs the post-reduction image data to the deep learning model, thereby reducing an information amount of a feature map extracted from an intermediate layer of the deep learning model. Moreover, the image processing device (edge device 120) according to the first embodiment compresses the post-reduction feature map with the reduced information amount.

As a result, according to the first embodiment, it becomes possible to improve the compression rate at the time of compressing the feature map extracted from the deep learning model.

### Second Embodiment

In the first embodiment described above, it has been described that the error having been subject to the backward propagation is used at the time of generating the important feature map. Meanwhile, in a second embodiment, individual feature maps extracted from individual layers of a preceding stage part are used at a time of generating an important feature map. Hereinafter, regarding the second embodiment, differences from the first embodiment described above will be mainly described.

### <Functional Configuration of Image Reduction Unit, Important Point Extraction Unit, and Compression Unit>

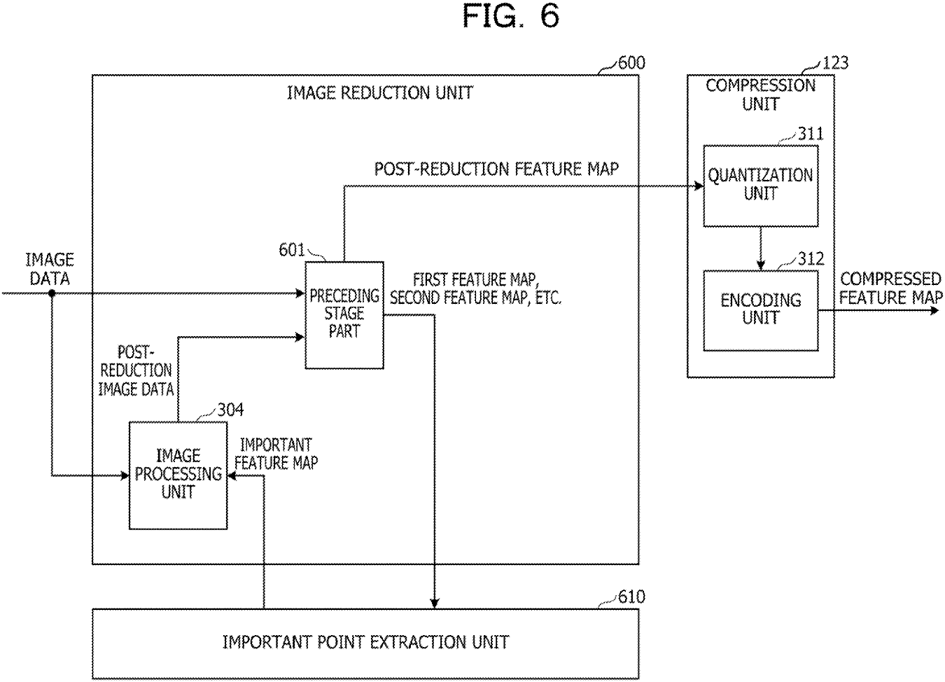

First, details of a functional configuration of an image reduction unit, an important point extraction unit, and a compression unit of an edge device 120, which is an exemplary image processing device according to the second embodiment, will be described. FIG. 6 is a second diagram illustrating an exemplary functional configuration of the image reduction unit, the important point extraction unit, and the compression unit of the edge device.

As illustrated in FIG. 6, an image reduction unit 600 is another exemplary reduction unit, which includes a preceding stage part 601 and an image processing unit 304.

The preceding stage part 601 includes individual layers from an input layer to an intermediate layer in a deep learning model 140. When image data is input, the preceding stage part 601 notifies an important point extraction unit 610 of feature maps (e.g., first feature map extracted from a first layer, second feature map extracted from a second layer, and so on) extracted from the individual layers.

Furthermore, when post-reduction image data is input, the preceding stage part 601 notifies a compression unit 123 of a post-reduction feature map extracted from the intermediate layer located at the rearmost position in the preceding stage part 601.

The image processing unit 304 reduces the information amount of the image data by processing the image data using the important feature map notified from the important point extraction unit 610, and generates the post-reduction image data. For example, the image processing unit 304 processes the image data according to a degree of attention of each pixel of the important feature map notified from the important point extraction unit 610, thereby reducing the information amount of the image data and generating the post-reduction image data.

Furthermore, the image processing unit 304 notifies the preceding stage part 601 of the generated post-reduction image data. Note that, as described above, the post-reduction feature map is extracted from the intermediate layer in the preceding stage part 601 to which the post-reduction image data is notified, and is notified to the compression unit 123.

The important point extraction unit 610 is another exemplary calculation unit, which generates the important feature map by weighting and adding the feature maps of the individual layers notified from the preceding stage part 601. Note that, in the second embodiment, the important feature map represents a degree of attention regarding which pixel has received attention when the individual layers of the preceding stage part 601 process the image data. The important point extraction unit 610 notifies the image processing unit 304 of the generated important feature map.

Furthermore, the compression unit 123 illustrated in FIG. 6 is the same as the compression unit 123 illustrated in FIG. 3, and thus descriptions thereof will be omitted here.

### <Specific Example of Processing of Image Reduction Unit and Important Point Extraction Unit>

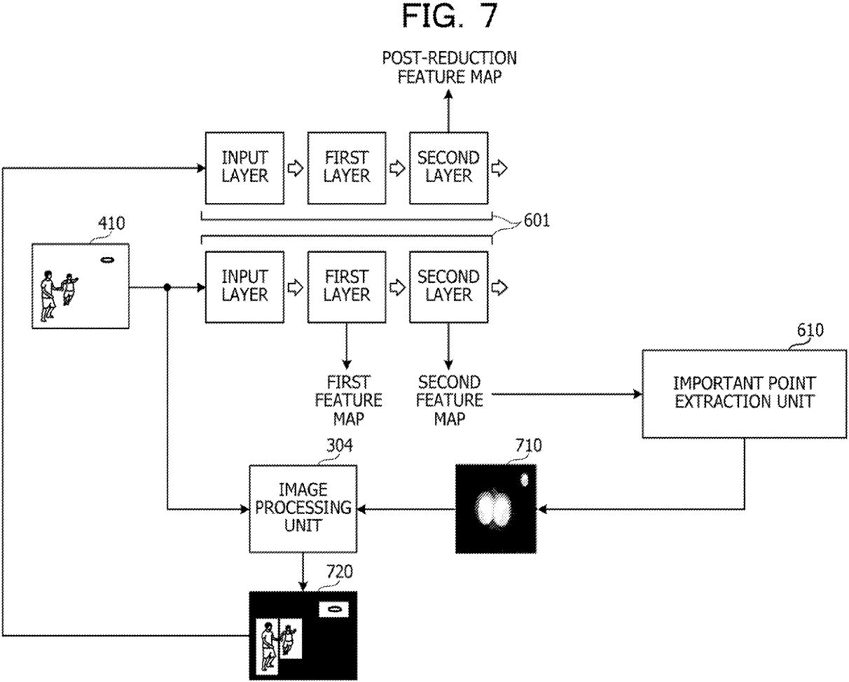

Next, a specific example of a process performed by the image reduction unit 600 and the important point extraction unit 610 of the edge device 120 will be described. FIG. 7 is a second diagram illustrating a specific example of the process performed by the image reduction unit and the important point extraction unit. As illustrated in FIG. 7, when image data 410 is input, the preceding stage part 601 operates in the image reduction unit 600 to extract a feature map from each layer. The example of FIG. 7 illustrates a state in which the preceding stage part 601 includes an input layer, a first layer, and a second layer, a first feature map is extracted from the first layer, and a second feature map is extracted from the second layer.

Subsequently, the important point extraction unit 610 operates to generate an important feature map 710 by weighting and adding the individual feature maps extracted from the preceding stage part 601. Note that, in the example of FIG. 7, pixels having a large degree of attention are indicated in white, and pixels having a small degree of attention are indicated in black in the important feature map 710.

Subsequently, the image processing unit 304 operates in the image reduction unit 121 to invalidate pixels with the degree of attention equal to or lower than a predetermined threshold in the important feature map 710 in the image data 410, thereby generating post-reduction image data 720.

Subsequently, the post-reduction image data 720 is input to the preceding stage part 601 in the image reduction unit 600 to cause the preceding stage part 601 to operate again, and a feature map is extracted from the intermediate layer (second layer in the example of FIG. 7) located at the rearmost position in the preceding stage part 601. Moreover, the image reduction unit 600 notifies the compression unit 123 of the extracted feature map as the post-reduction feature map.

### <Compression Process Flow of Edge Device>

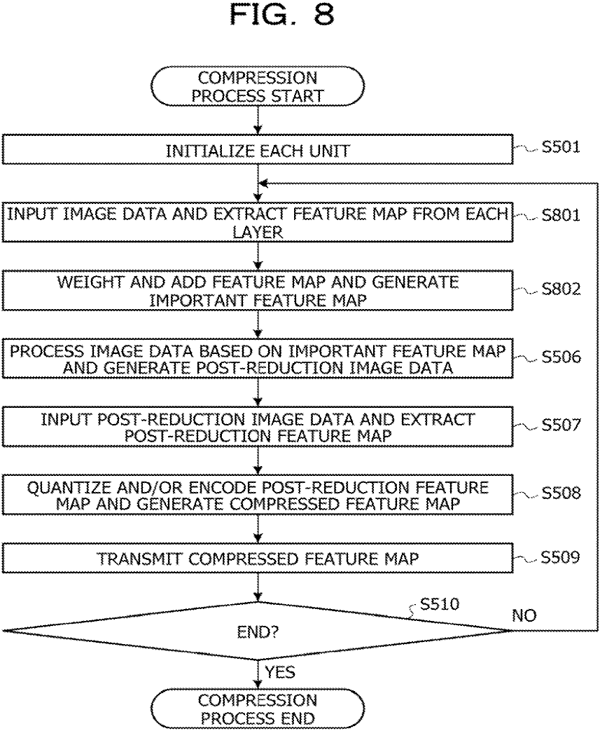

Next, a flow of a compression process performed by the edge device 120 will be described. FIG. 8 is a second flowchart illustrating a flow of the compression process performed by the edge device. Differences from the first flowchart described with reference to FIG. 5 are steps S801 and S802.

In step S801, the image reduction unit 600 of the edge device 120 causes the preceding stage part 601 to operate. When image data is input, the preceding stage part 601 extracts feature maps from the individual layers.

In step S802, the important point extraction unit 610 of the edge device 120 weights and adds the individual feature maps extracted from the individual layers of the preceding stage part 601, thereby generating an important feature map.

As is clear from the descriptions above, the image processing device (edge device 120) according to the second embodiment calculates a degree of attention of each pixel of image data, the attention being paid by each layer when the image data is input to the deep learning model 140, and generates an important feature map. Furthermore, the image processing device (edge device 120) according to the second embodiment processes the image data based on the important feature map, thereby reducing the information amount of the image data. Furthermore, the image processing device (edge device 120) according to the second embodiment inputs the post-reduction image data to the deep learning model, thereby reducing an information amount of a feature map extracted from an intermediate layer of the deep learning model. Moreover, the image processing device (edge device 120) according to the second embodiment compresses the post-reduction feature map with the reduced information amount.

As a result, according to the second embodiment, it becomes possible to improve the compression rate at the time of compressing the feature map extracted from the deep learning model.

### Third Embodiment

In the first embodiment described above, the case where the information amount of the image data is reduced by processing the image data based on the important feature map and the information amount of the feature map extracted from the intermediate layer of the deep learning model is reduced by inputting the post-reduction image data to the deep learning model has been described.

Meanwhile, in a third embodiment, a case of directly reducing an information amount of a feature map extracted from an intermediate layer of a deep learning model based on an important feature map will be described. Hereinafter, regarding the third embodiment, differences from the first embodiment described above will be mainly described.

### <Functional Configuration of Image Reduction Unit, Important Point Extraction Unit, and Compression Unit>

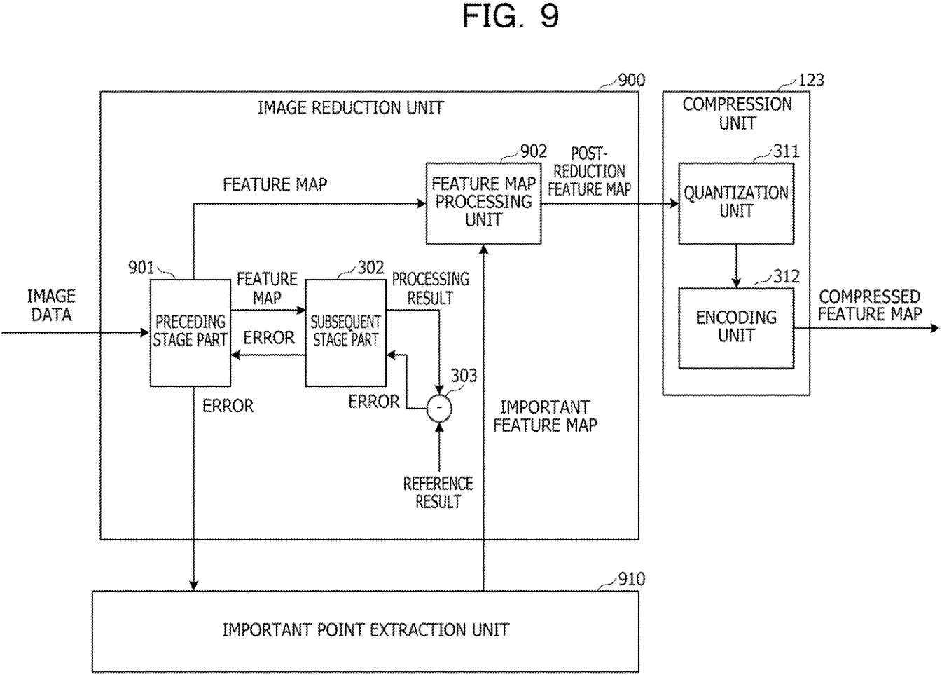

First, details of a functional configuration of an image reduction unit, an important point extraction unit, and a compression unit of an edge device 120, which is an exemplary image processing device according to the third embodiment, will be described. FIG. 9 is a third diagram illustrating an exemplary functional configuration of the image reduction unit, the important point extraction unit, and the compression unit of the edge device.

As illustrated in FIG. 9, an image reduction unit 900 is another exemplary reduction unit, which includes a preceding stage part 901, a subsequent stage part 302, an error calculation unit 303, and a feature map processing unit 902.

The preceding stage part 901 includes individual layers from an input layer to an intermediate layer from which a feature map is extracted in a deep learning model 140. When image data is input, the preceding stage part 901 extracts the feature map from the intermediate layer, and notifies the subsequent stage part 302 and the feature map processing unit 902 of it.

The subsequent stage part 302 and the error calculation unit 303 are the same as the subsequent stage part 302 and the error calculation unit 303 described with reference to FIG. 3 in the first embodiment described above, and thus descriptions thereof will be omitted here.

The feature map processing unit 902 processes the feature map based on an important feature map notified from an important point extraction unit 910 to reduce the information amount of the feature map, thereby generating a post-reduction feature map. For example, the feature map processing unit 902 processes the feature map based on a degree of influence of each pixel of the important feature map notified from the important point extraction unit 910 to reduce the information amount of the feature map, thereby generating the post-reduction feature map.

Note that a method of processing the feature map by the feature map processing unit 902 is optional. For example, a pixel with a degree of influence equal to or lower than a predetermined threshold may be specified in the important feature map, and the pixel value of the specified pixel in the feature map may be set to zero (the specified pixel may be invalidated). Alternatively, a pixel with a degree of influence equal to or lower than the predetermined threshold may be specified in the important feature map, and the specified pixel may be subject to low-pass filtering in the feature map.

Furthermore, the feature map processing unit 902 notifies the compression unit 123 of the generated post-reduction feature map.

The important point extraction unit 910 is another exemplary calculation unit, which generates an important feature map using an error having been subject to backward propagation. As described in the first embodiment above, the important feature map indicates the degree of influence of each pixel in the image data on the processing result. The important point extraction unit 910 notifies the feature map processing unit 902 of the generated important feature map.

Furthermore, the compression unit 123 illustrated in FIG. 9 is the same as the compression unit 123 illustrated in FIG. 3, and thus descriptions thereof will be omitted here.

### <Specific Example of Processing of Image Reduction Unit and Important Point Extraction Unit>

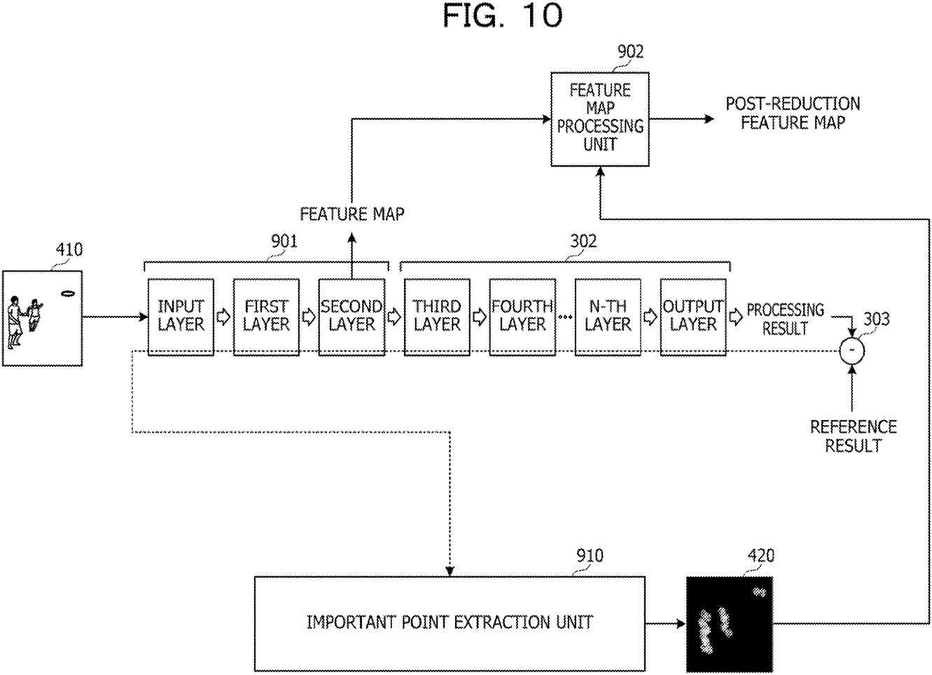

Next, a specific example of a process performed by the image reduction unit 900 and the important point extraction unit 910 of the edge device 120 will be described. FIG. 10 is a third diagram illustrating a specific example of the process performed by the image reduction unit and the important point extraction unit. As illustrated in FIG. 10, when image data 410 is input, the preceding stage part 901 operates to extract a feature map, and the subsequent stage part 302 also operates to output a processing result in the image reduction unit 900.

Subsequently, the error calculation unit 303 operates in the image reduction unit 900 to calculate an error between the processing result and a reference result, and then performs backward propagation of the calculated error.

Subsequently, the important point extraction unit 910 operates to generate an important feature map 420 using the error having been subject to the backward propagation.

subsequently, in the image reduction unit 900, the feature map processing unit 902 operates to invalidate pixels with the degree of influence equal to or lower than a predetermined threshold in the important feature map 420 with respect to the feature map extracted from the preceding stage part 901, thereby generating the post-reduction feature map.

### <Compression Process Flow of Edge Device>

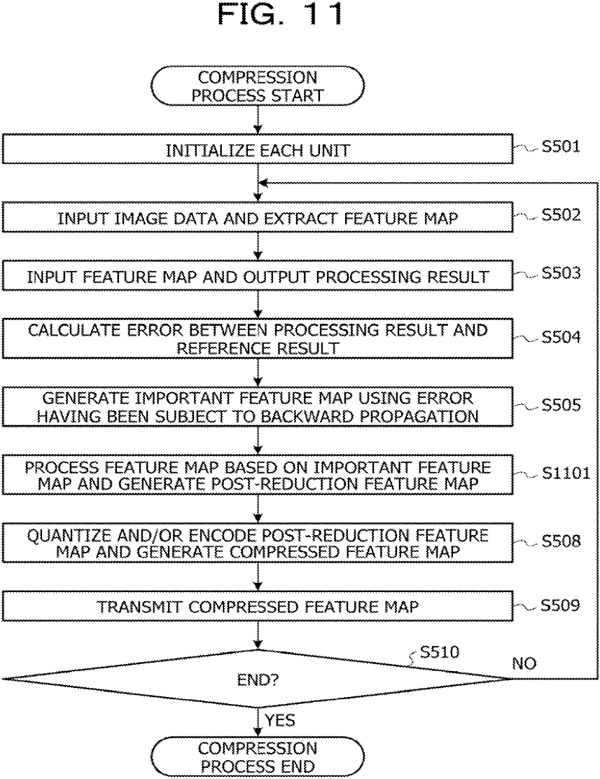

Next, a flow of a compression process performed by the edge device 120 will be described. FIG. 11 is a third flowchart illustrating a flow of the compression process performed by the edge device. A difference from the first flowchart described with reference to FIG. 5 is step S1101.

In step S1101, the image reduction unit 900 of the edge device 120 causes the feature map processing unit 902 to operate. The feature map processing unit 902 processes the feature map based on the important feature map to reduce the information amount of the feature map, thereby generating a post-reduction feature map.

As is clear from the descriptions above, the image processing device (edge device 120) according to the third embodiment calculates a degree of influence of each pixel of image data, which affects the processing result when the image data is input to the deep learning model 140, and generates an important feature map. Furthermore, the image processing device (edge device 120) according to the third embodiment processes a feature map extracted from an intermediate layer of the deep learning model based on the important feature map, thereby reducing the information amount of the feature map. Moreover, the image processing device (edge device 120) according to the third embodiment compresses the post-reduction feature map with the reduced information amount.

As a result, according to the third embodiment, it becomes possible to improve the compression rate at the time of compressing the feature map extracted from the deep learning model.

### Fourth Embodiment

In the second embodiment described above, the case where the information amount of the image data is reduced by processing the image data based on the important feature map and the information amount of the feature map extracted from the intermediate layer of the deep learning model is reduced by inputting the post-reduction image data to the deep learning model has been described.

Meanwhile, in a fourth embodiment, a case of directly reducing an information amount of a feature map extracted from an intermediate layer of a deep learning model based on an important feature map will be described. Hereinafter, regarding the fourth embodiment, differences from the second embodiment described above will be mainly described.

### <Functional Configuration of Image Reduction Unit, Important Point Extraction Unit, and Compression Unit>

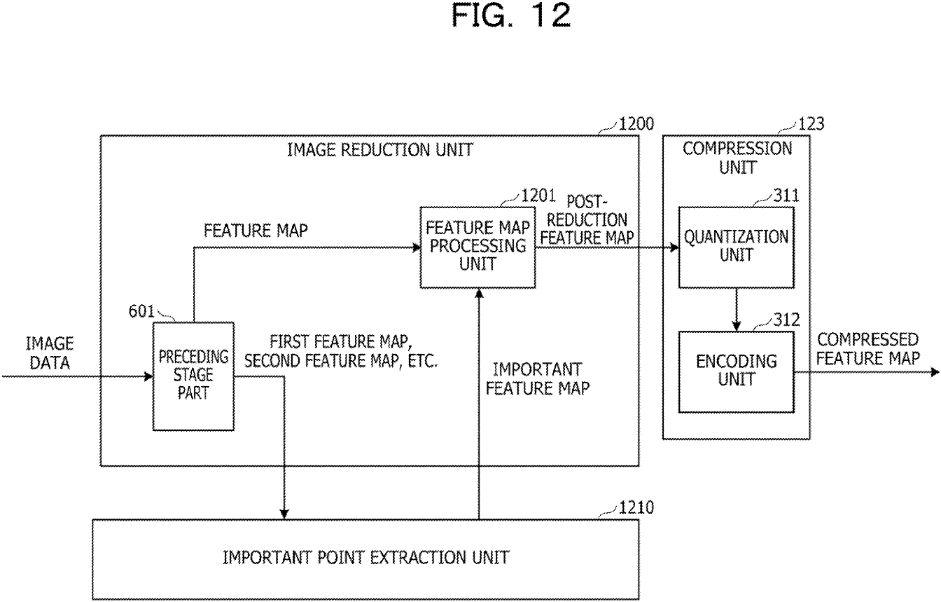

First, details of a functional configuration of an image reduction unit, an important point extraction unit, and a compression unit of an edge device 120, which is an exemplary image processing device according to the fourth embodiment, will be described. FIG. 12 is a fourth diagram illustrating an exemplary functional configuration of the image reduction unit, the important point extraction unit, and the compression unit of the edge device.

As illustrated in FIG. 12, an image reduction unit 1200 is another exemplary reduction unit, which includes a preceding stage part 601 and a feature map processing unit 1201.

The preceding stage part 601 is the same as the preceding stage part 601 described with reference to FIG. 6 in the second embodiment described above, and thus descriptions thereof will be omitted here.

The feature map processing unit 1201 processes the feature map using an important feature map notified from an important point extraction unit 1210 to reduce the information amount of the feature map, thereby generating a post-reduction feature map. For example, the feature map processing unit 1201 processes the feature map according to a degree of attention of each pixel of the important feature map notified from the important point extraction unit 1210 to reduce the information amount of the feature map, and notifies a compression unit 123 of the post-reduction feature map.

The important point extraction unit 1210 is another exemplary calculation unit, which generates the important feature map by weighting and adding the feature maps of the individual layers notified from the preceding stage part 601. Note that, as described in the second embodiment above, the important feature map represents a degree of attention regarding which pixel has received attention when the individual layers of the preceding stage part 601 process the image data. The important point extraction unit 1210 notifies the feature map processing unit 1201 of the generated important feature map.

Furthermore, the compression unit 123 illustrated in FIG. 12 is the same as the compression unit 123 illustrated in FIG. 3, and thus descriptions thereof will be omitted here.

### <Specific Example of Processing of Image Reduction Unit and Important Point Extraction Unit>

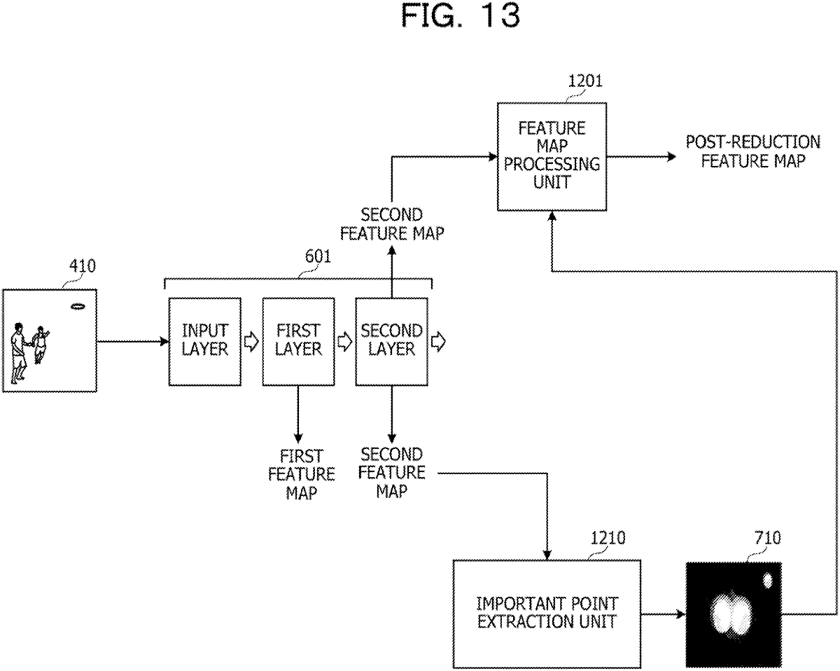

Next, a specific example of a process performed by the image reduction unit 1200 and the important point extraction unit 1210 of the edge device 120 will be described. FIG. 13 is a fourth diagram illustrating a specific example of the process performed by the image reduction unit and the important point extraction unit. As illustrated in FIG. 13, when image data 410 is input, the preceding stage part 601 operates in the image reduction unit 1200 to extract a feature map from each layer. The example of FIG. 13 illustrates a state in which the preceding stage part 601 includes an input layer, a first layer, and a second layer, a first feature map is extracted from the first layer, and a second feature map is extracted from the second layer.

Subsequently, the important point extraction unit 1210 operates to generate an important feature map 710 by weighting and adding the individual feature maps extracted from the preceding stage part 601.

Subsequently, the feature map processing unit 1201 operates in the image reduction unit 1200. The feature map processing unit 1201 obtains the feature map (feature map extracted from the intermediate layer (second layer in the example of FIG. 13) located at the rearmost position in the preceding stage part 601) extracted from the preceding stage part 601. Furthermore, the feature map processing unit 1201 invalidates pixels with the degree of attention equal to or lower than a predetermined threshold in the important feature map 710 in the obtained feature map, thereby generating a post-reduction feature map.

### <Compression Process Flow of Edge Device>

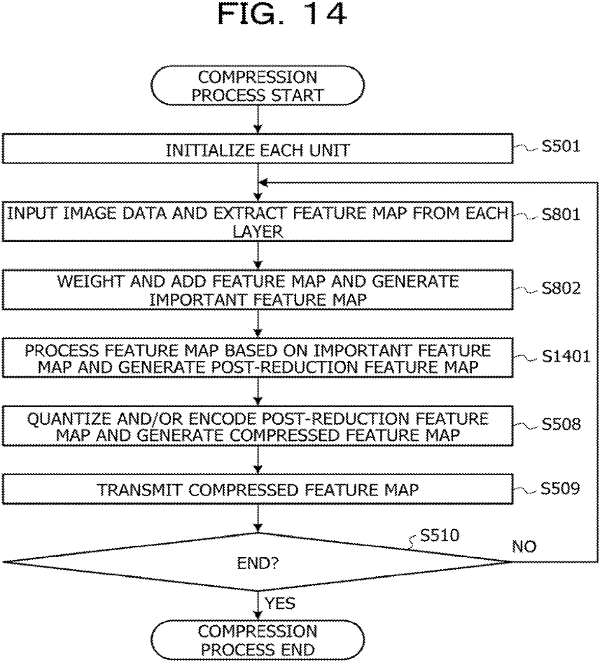

Next, a flow of a compression process performed by the edge device 120 will be described. FIG. 14 is a fourth flowchart illustrating a flow of the compression process performed by the edge device. A difference from the second flowchart described with reference to FIG. 8 is step S1401.

In step S1401, the image reduction unit 1200 of the edge device 120 causes the feature map processing unit 1201 to operate. The feature map processing unit 1201 processes the feature map based on the important feature map to reduce the information amount of the feature map, thereby generating a post-reduction feature map.

As is clear from the descriptions above, the image processing device (edge device 120) according to the fourth embodiment calculates a degree of attention of each pixel of image data, the attention being paid by each layer when the image data is input to the deep learning model 140, and generates an important feature map. Furthermore, the image processing device (edge device 120) according to the fourth embodiment processes a feature map extracted from an intermediate layer of the deep learning model based on the important feature map, thereby reducing the information amount of the feature map. Moreover, the image processing device (edge device 120) according to the fourth embodiment compresses the post-reduction feature map with the reduced information amount.

As a result, according to the fourth embodiment, it becomes possible to improve the compression rate at the time of compressing the feature map extracted from the deep learning model.

### Other Embodiments

In the first and second embodiments described above, it has been described that the image data used to generate the important feature map and the image data processed based on the important feature map are the same image data. However, image data used to generate an important feature map and image data processed based on the important feature map may be image data captured at different timings. However, in the case of the image data captured at different timings, it is assumed that the important feature map is converted according to a time interval of both pieces of the image data, and the image data is processed based on the converted important feature map.

Similarly, in the third and fourth embodiments described above, it has been described that the image data used to generate the important feature map and the image data when the feature map to be processed based on the important feature map is extracted are the same image data. However, the image data used to generate the important feature map and the image data when the feature map to be processed based on the important feature map is extracted may be image data captured at different timings. However, in the case of the image data captured at different timings, it is assumed that the important feature map is converted according to the time interval of both pieces of the image data, and the feature map is processed based on the converted important feature map.

Furthermore, although not mentioned in the first to fourth embodiments described above, the image data used to generate the important feature map and the image data processed based on the important feature map may be captured at different timings. Alternatively, the image data used to generate the important feature map and the image data when the feature map to be processed based on the important feature map is extracted may be image data captured at different timings.

Furthermore, the individual components in the image reduction units 121, 600, 900, and 1200 described in the first to fourth embodiments above may not be arranged at the positions exemplified in the first to fourth embodiments described above. Similarly, the individual components in the important point extraction units 122, 610, 910, and 1210 described in the first to fourth embodiments above may not be arranged at the positions exemplified in the first to fourth embodiments described above. For example, the individual components may be arranged in another device coupled via a network. Furthermore, the individual components may be arranged in a plurality of devices.

Note that the real intention of the present disclosure lies in that, when the deep learning model 140 performs image analysis processing,
extracting an importance level of each pixel for extracting a target object from information of any point of the deep learning model 140; and
reducing, based on the extracted information, an information amount at any point (point having an effect of reducing the information amount of intermediate information) of the processing of the deep learning model 140 including image data,
and a method for extracting the information that satisfies the purpose may be a method other than the extraction method mentioned in the individual embodiments described above.

Furthermore, as exemplified in the individual embodiments described above, the information extraction may be carried out at a point needed for the information extraction, such as the preceding stage part or the subsequent stage part in the deep learning model 140. The point needed for the information extraction may be the point exemplified in the individual embodiments described above, a part thereof, or another point. For example, it is sufficient if the purpose of the information extraction method described above is satisfied.

Furthermore, when the extended selective backpropagation mentioned in the first embodiment described above is carried out, an error at any point of the deep learning model 140 may be used. For example, in the first embodiment described above, the subsequent stage part may not be used at the time of deriving the important feature map based on the extended selective backpropagation.

Furthermore, while the compression unit 123 described in each of the embodiments described above compresses the post-reduction feature map notified from the image reduction unit 121 by performing quantization and/or encoding processing, it may compress a single post-reduction feature map by performing the quantization and/or encoding processing. Alternatively, the compression may be carried out by performing the quantization and/or encoding processing using a correlation of a plurality of post-reduction feature maps. Examples of using the correlation of the plurality of post-reduction feature maps include a moving image and the like.

Note that the embodiments are not limited to the configurations described here, and may include combinations of the configurations or the like described in the above embodiments with other elements, and the like. These points may be changed without departing from the spirit of the embodiments, and may be appropriately defined according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing device comprising:
a memory; and
a processor coupled to the memory and configured to:
calculate a degree of influence of each pixel of image data, the influence being exerted on a processing result when the image data is input to a deep learning model;
reduce an information amount of intermediate information extracted from the deep learning model based on the degree of influence; and
compress the intermediate information, the information amount of which has been reduced.

2. The image processing device according to claim 1, wherein
the processor
reduces the information amount of the intermediate information extracted from the deep learning model by processing a pixel of the image data with the degree of influence equal to or lower than a predetermined threshold and inputting the processed image data to the deep learning model.

3. The image processing device according to claim 1, wherein
the processor
reduces the information amount of the intermediate information by processing a pixel of the intermediate information with the degree of influence equal to or lower than a predetermined threshold.

4. An image processing device comprising:
a memory; and
a processor coupled to the memory and configured to:
calculate a degree of attention of each pixel of image data, the attention being paid by each layer when the image data is input to a deep learning model;
reduce an information amount of intermediate information extracted from the deep learning model based on the degree of attention; and
compress the intermediate information, the information amount of which has been reduced.

5. The image processing device according to claim 4, wherein
the processor
reduces the information amount of the intermediate information extracted from the deep learning model by processing a pixel of the image data with the degree of attention equal to or lower than a predetermined threshold and inputting the processed image data to the deep learning model.

6. The image processing device according to claim 4, wherein
the processor
reduces the information amount of the intermediate information by processing a pixel of the intermediate information with the degree of attention equal to or lower than a predetermined threshold.

7. An image processing method comprising:
calculating a degree of influence of each pixel of image data, the influence being exerted on a processing result when the image data is input to a deep learning model;
reducing an information amount of intermediate information extracted from the deep learning model based on the degree of influence; and
compressing the intermediate information, the information amount of which has been reduced.
